(19) United States
(12) Patent Application Publication
(10) Pub. No.: US 2026/0011478 A1
(43) Pub. Date: Jan. 8, 2026

(54) ELECTROMAGNETIC CORES, PUMPS USING THE SAME, AND METHODS OF MANUFACTURING THE SAME

(71) Applicant: GE-Hitachi Nuclear Energy Americas LLC, Wilmington, NC (US)

(72) Inventors: Scott A. Wagner, Grosse Pointe, MI (US); Nikolas Davis, Tulsa, OK (US)

(21) Appl. No.: 18/765,238

(22) Filed: Jul. 6, 2024

(51) Int. Cl. H01F 27/24; H01F 41/02

(52) U.S. Cl. CPC H01F 27/24; H01F 41/0206

(57) ABSTRACT

Systems and methods use bodies with multiple teeth that follow a magnetic field in the body. The teeth have adjacent gaps while the body remains a continuous rigid structure. The gaps may be any shape or size formed by removal from the parent body while preserving a continuous joining portion of the body. Cutting with electrical discharge wires or lasers may be used for the gaps. The body may take on any shape or size, including electromagnetic pump stator configurations. Recesses, including ledges, passages, toughs, bores, rounds, or flat faces may be formed with the gaps. Adjacent recesses between multiple bodies may form other functional passages, such as an angular or perimeter passage for driving coils in an electromagnetic pump. Insulators may be placed into the gaps. Example systems and methods require fewer additional joining or supporting structures due to the teeth already being connected from fabrication.

### BACKGROUND

FIG. 1 is a perspective view of a related art stator core 1, such as an inner stator core useable in a linear electromagnetic pump. As seen in FIG. 1, stator core 1 is made up of several lamination sections 10 joined to an inner guide 11. FIG. 2 illustrates lamination section 10 in greater detail, showing it is assembled of multiple discreet sheets 15 each punched or machined from a parent ferromagnetic source. Each sheet 15 may be coated with insulation or have insulation filled between adjacent sheets 15. Multiple sheets 15, potentially fifteen, twenty, or more, are aligned and joined by tie rod 16 passing through sheets 15 and holding them as a single lamination section 10. End pieces 17 allow tie rods 16 to anchor and secure the separate sheets 15 together, such that section 10 acts as a rigid, modular body with all sheets 15 kept in alignment.

FIG. 3 is an axial cross-section of a related art electromagnetic pump 20 using related art stator core 1. Outer stator core 2 may be positioned about inner stator core 1 to form an annular channel 22. Outer stator core 2 is also made up of lamination sections 10 similar to inner stator core 1, with each section being joined to structural support 5. Pump case 21 surrounds stators 1 and 2 and guides fluid into annular channel 22. As current is run through induction coils passing in a circular direction within stator cores 1 and 2, resultant magnetic fields in the ferromagnetic portions of the lamination sections 10 drive the fluid in channel 22 in an axial direction due to perpendicular electrical fields or current. U.S. Pat. No. 4,642,882 to Castiglione et al.; U.S. Pat. No. 5,440,600 to Fanning; and U.S. Pat. No. 6,603,224 to Hollingsworth et al.; and CN Patent 114,640,233 to Zhejiang University ZJU describe electromagnetic pumps having various stator configurations and/or methods of fabricating the same, and are incorporated by reference herein in their entireties.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include magnetic elements with multiple columns, fingers, or teeth extensions in a length that will follow a magnetic field in the element. The extensions are created by adjacent gaps in the element, but the gaps do not fully segment or separate the element. In this way, the element is a single piece, with all extensions being connected as part of a materially-continuous whole that lacks additional joining structures or materials. The gaps may be numerous and small, down to small fractions of an inch in width, so as to produce many extensions finely separated from one another. Any removal method, including machining and lasers, may be used to form the gaps in an otherwise solid element. Example embodiment magnetic elements may be any shape or size, including curved or annular cores useable as electromagnetic pump stators. Where the gaps have a length that extends into the curve, they may stop to form a spine or other solid connector that unites all the extensions while remaining relatively small to avoid large amounts of current and/or heat from transferring throughout the element via the connector.

Other shapes, including ledges, passages, toughs, bores, rounded or flat faces, etc. may be formed in example magnetic elements before or after the gaps are formed, such that example embodiment magnetic elements may take on any physical configuration. For example, where example elements are stacked as a stator in an electromagnetic pump, the elements may be shaped with a passage formed in a middle center of the stator to accommodate driving coils. Example embodiment magnetic elements are compatible with any additional materials, including solid or mixed phase insulators occupying the gaps and/or on any other element surface.

In this way, example embodiment elements may not require assembly of multiple discreet pieces of ferromagnetic materials with connectors, spacers, or other positioning devices, and the magnetic material, such as a ferromagnetic alloy or single-piece iron may extend through a larger volume. This may produce more efficient driving forces in devices like electromagnetic pumps, while requiring less assembly and manufacturing by using fewer parts.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art inner stator core using lamination sections.

FIG. 2 is a detail illustration of a related art lamination section.

FIG. 3 is an axial cross-section of a related art electromagnetic pump.

FIG. 4 is a perspective view of an example embodiment core.

FIG. 5 is a top view of the example embodiment core of FIG. 4.

FIG. 6 is a perspective partial view of another example embodiment core.

FIG. 7 is a top view of the example embodiment core of FIG. 6.

FIG. 8 is a perspective view of an example embodiment pump using a stack of example embodiment cores as a stator.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being a longest dimension of the feature.

The inventors have recognized that electromagnetic device stators use multiple discreet parts to allow full insulation of these parts, including teeth individually cut, laminated, aligned, and bound together into a section that is then joined by fasteners to other structures. This complexity limits the shaping of stators, increases fabrication costs and risk of part loss, and requires many additional joining and supporting structures. Modular assembled sections often have gaps and other non-functional joining components that do not contribute to a driving magnetic field. The inventors have newly recognized that complete insulation between core components used in related art lamination sections may not be required with positioning and sizing of connected portions. To overcome these newly-recognized problems as well as others, the inventors have developed example embodiments and methods described below to address these and other problems recognized by the inventors with unique solutions enabled by example embodiments.

The present invention is magnetic cores, electromagnetic devices using magnetic cores as stators, and methods of fabricating and using the same. In contrast to the present invention, the few example embodiments and example methods discussed below illustrate just a subset of the variety of different configurations that can be used as and/or in connection with the present invention.

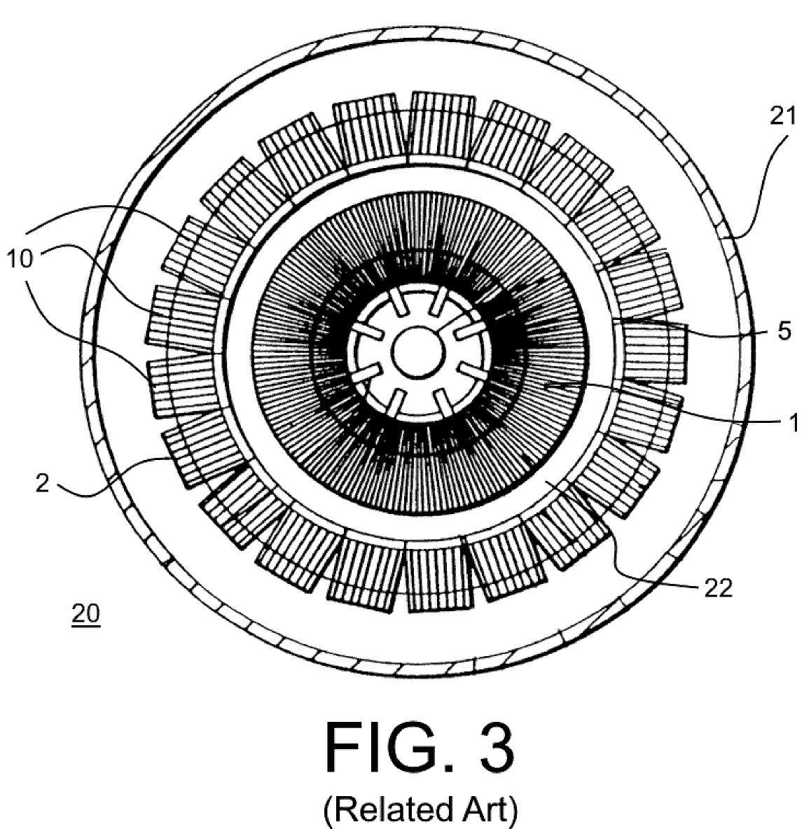

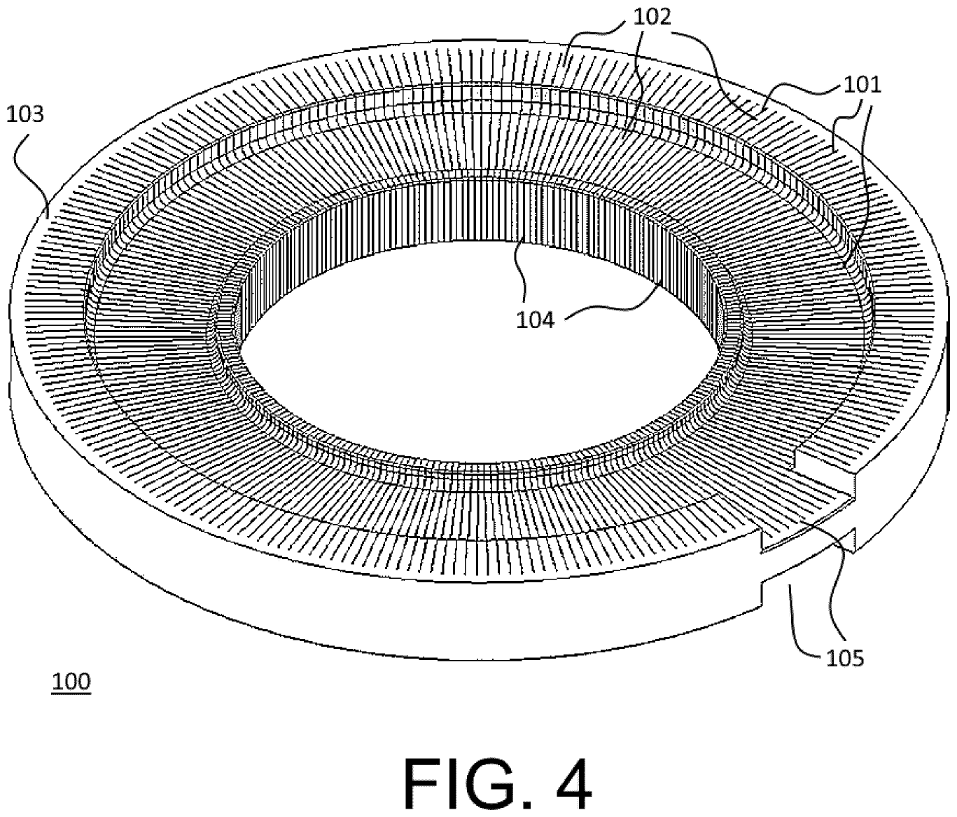

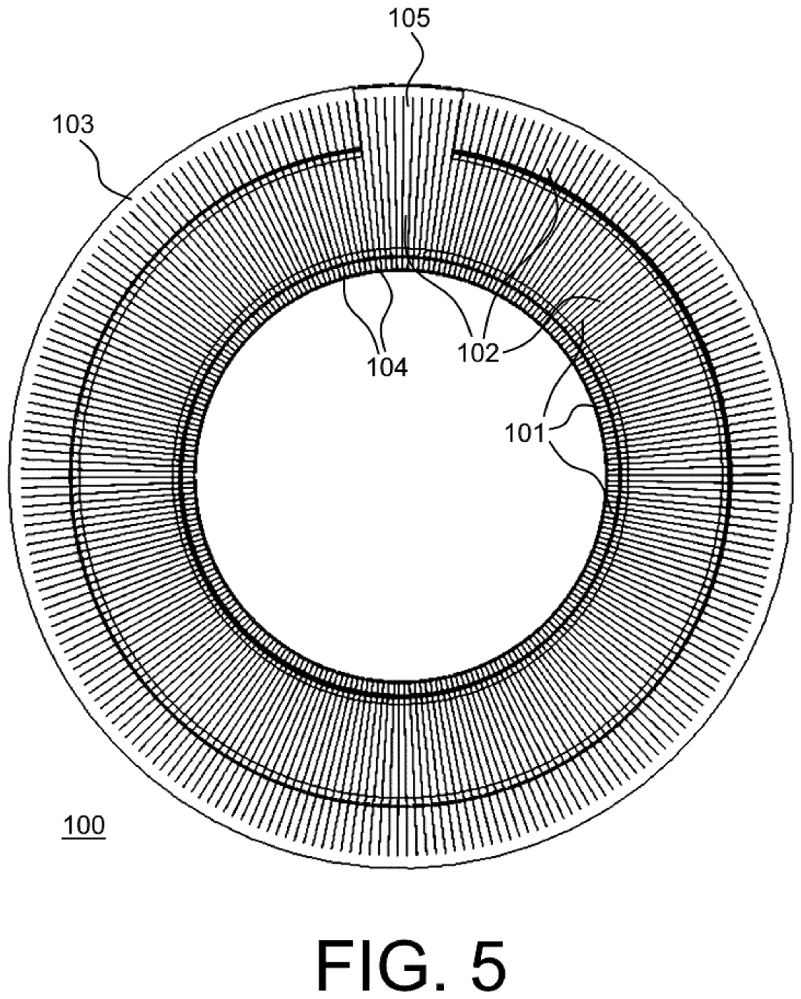

Example embodiment structures include magnetic cores formed from parent or blank magnetic materials. Example embodiments may be fabricated from a variety of parent magnetic materials, including sheets, billets, annuli, etc. that are forged, annealed, cast, cut, or otherwise shaped in a starting parent shape. FIG. 4 is an illustration of an example embodiment magnetic core 100 useable as a stator in an electromagnetic device, including electromagnetic pumps. For example, core 100 may be used as an outer stator like outer stator 2 in related art pump 20 of FIG. 3. Example embodiment ferromagnetic core 100 may be fabricated of any magnetic material, including metal alloys and/or solid iron. Although core 100 is shown as a complete annulus in FIG. 4, it is understood that other shapes and sections are useable for core 100, based on the shape of the parent material from which core 100 is cut, such as with forging, cutting, and/or machining.

As shown in FIG. 4, core 100 includes several radial slots 101 cut nearly a full radial width of core 100. Radial slots 101 form teeth 102 between the slots, which are columns or fingers extending longest in a dimension associated with a radial magnetic field. Solid section 103 may join all teeth 102 at a back or furthermost position from a start of slots 101. Although slots 101 may be any length into core 100, longer slots, with solid section 103 remaining only of a thickness sufficient to provide rigid strength for core 100, may best prevent angular or azimuthal currents from flowing through solid section 103 and different teeth 102. For example, slots 101 may extend about 80% in a radial direction of core 100, or even over 90% of a radial thickness of core 100, and solid section 103 may be relatively small, such as only 0.25 in thick in common stator applications.

Slots 101 may be of any number, pitch, and thickness, with resulting characteristics of teeth 102. For example, each slot 101 may be cut, such as through electrical discharge machining, wire EDM, water jet, band saw, and/or laser cutting, from a solid magnetic material. Precision machining may allow slots 101 be thin, such as 0.01 down to 0.0001-inches, in an azimuthal or angular direction of core 100. This thickness may be perpendicular to the radial distance or length of slots 101 discussed above. The pitch of slots 101 may be chosen based on a desired operating frequency of a stator and/or pump in which core 100 may be used. For example, slots 101 may be spaced every 0.05-0.1 inches, such that teeth 102 have that thickness. In the example of FIGS. 4-5, this may result in dozens, or hundreds, of teeth 102 across an inner perimeter of core 100.

While slots 101 and teeth 102 may be substantially straight with uniform shapes and size, these may also be varied in individual slots 101 to form differing teeth 102. For example, angled, curved, and/or wavy slots 101 with individually uniform or varying height and width may be used, or teeth 102 may be different sizes or shapes from one another. These different shapes and sizes may be chosen to accommodate additional elements between or through core 100 such as powering coils, insulation, or any other element, as well as to vary and achieve desired magnetic properties of the same.

Insulation 104 may be filled between teeth 102 in slots 101 to impart desired heat and/or electrical isolation/transfer between teeth 102. Any dielectric material may be used for insulation 104, including air allowed to pass into open slots 101. Insulation 104 that forms or is a solid material may be introduced into slots 101 through vapor deposition, plating, water-based solutions such as a water-based aluminum oxide coating, vacuum fill, oxidation, paint on and then bake, etc. to achieve desired uniformity and heat and electrical properties between teeth 102. Similarly, insulating materials may be placed on tops and bottoms of teeth 102, potentially surrounding them and/or example embodiment core 100.

As seen in FIG. 5, example embodiment core 100 may include teeth 102 and slots 101 arrayed along an entire inner perimeter of core 100. In the example of an annular core 100, this may form a closed inner circle. Compared to the related art lamination sections 10 seen in FIG. 3, example embodiment core 100 has fewer gaps and parts, with denser ferromagnetic material positioned around core 100 having no such gaps. Moreover, example embodiment core 100 may not include any separate joining piece or assembly, because after being cut to solid section 103, teeth 102 are all rigidly secured together as part of an integral of the material from which they were cut, without internal discontinuity or separate joining structures.

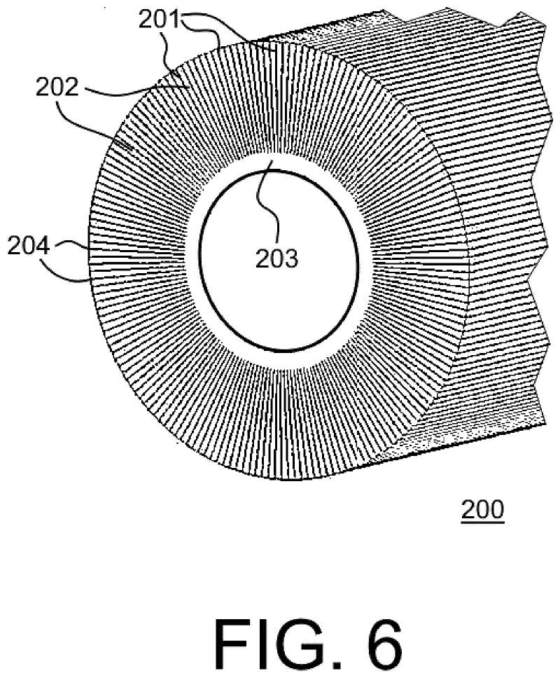

FIG. 6 is an illustration of another example embodiment core 200 useable as a stator in an electromagnetic device, including electromagnetic pumps. For example, example embodiment magnetic core 200 may be used as an inner stator like inner stator 1 in related art pump 20 of FIG. 3. Like core 100 of FIGS. 2-3, example embodiment core 200 may be fabricated of any magnetic material, including metal alloys and/or solid iron. Although core 200 is shown as a complete annulus in FIG. 6, it is understood that other shapes and sections are useable for core 100, given the shape of the magnetic material from which it is formed by forging, cutting, and/or machining.

As shown in FIG. 6, core 200 includes several radial slots 201 cut nearly a full radial width of core 200. Radial slots 201 form teeth 202 between the slots, which are columns or fingers extending longest in a dimension associated with a radial magnetic field. Solid section 203 may join all teeth 202 at an inner or furthermost position from a start of slots 201. Although slots 201 may be any radial length into core 200, longer slots, with solid section 203 remaining only of a thickness sufficient to provide rigid strength for core 200, may best prevent angular or azimuthal currents from flowing through solid section 203 and different teeth 202. For example, slots 201 may extend about 80% or more, such as over 90%, of a radial thickness of core 200.

Slots 201 may be of any number, pitch, and thickness, with resulting characteristics of teeth 202. For example, slots 201 may be cut, such as through electrical discharge machining, wire EDM, water jet, band saw, and/or laser cutting, from a solid magnetic material down to 0.0001-inch tolerance for example in an azimuthal or angular direction of core 200. This thickness may be perpendicular to the radial dimension or length of slots 201 discussed above. The pitch of slots 201 may be chosen based on a desired operating frequency of a stator and/or pump in which core 200 may be used. For example, slots 201 may be spaced every 0.05-0.1 inches, such that teeth 202 have that thickness. Similarly, teeth 202 and slots 201 may be individually varied in sizes, and they may be positioned to match slots 101 of core 100 (FIGS. 4-5) in position and number if paired in an electromagnetic pump. While slots 201 and teeth 202 may be substantially straight with uniform shapes and size, these may also be varied in individual slots 201 to form differing teeth 202. For example, angled, curved, and/or wavy slots 201 with individually uniform or varying height and width may be used, or teeth 202 may be different sizes or shapes from one another. These different shapes and sizes may be chosen to accommodate additional elements between or through core 200 such as powering coils, insulation, or any other element, as well as to vary and achieve desired magnetic properties of the same.

Insulation 204 may be filled between teeth 202 in slots 201 to impart desired heat and/or electrical isolation/transfer between teeth 202. Any dielectric material may be used for insulation 204, including air allowed to pass into open slots 201. Insulation 204 fabricated of or forming a solid material may be introduced into slots 201 through vapor deposition, plating, water-based solutions such as a water-based aluminum oxide coating, vacuum fill, oxidation, paint on and then bake, etc. to achieve desired uniformity and heat and electrical properties between teeth 202. Similarly, insulating materials may be placed on tops and bottoms of teeth 202, potentially surrounding them and/or example embodiment core 200.

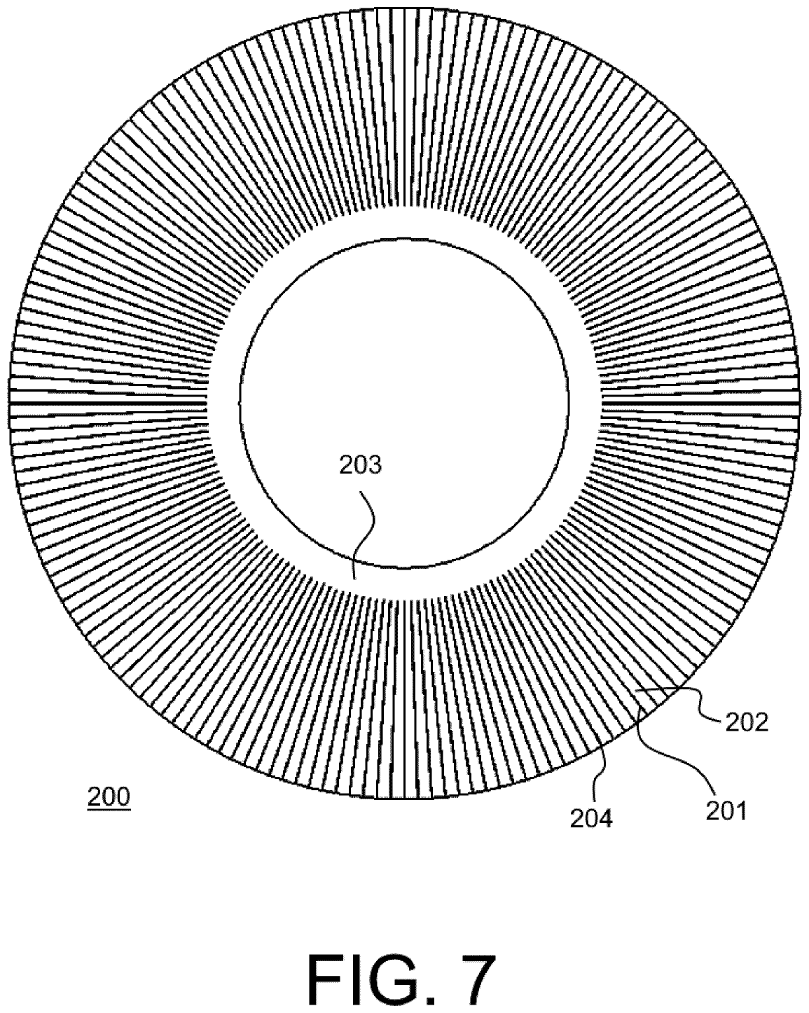

As seen in FIG. 7, example embodiment core 200 may include teeth 202 and slots 201 arrayed along an entire outer perimeter of core 200. In the example of an annular core 200, this may form a closed outer circle. Compared to the related art lamination sections 10 seen in FIG. 3, example embodiment core 200 has fewer parts. Example embodiment core 200 may not require separate joining or end pieces for each lamination, because after being cut to solid section 203, teeth 202 are all rigidly secured together as part of an integral of the material from which they were cut, without internal discontinuity or separate joining structures.

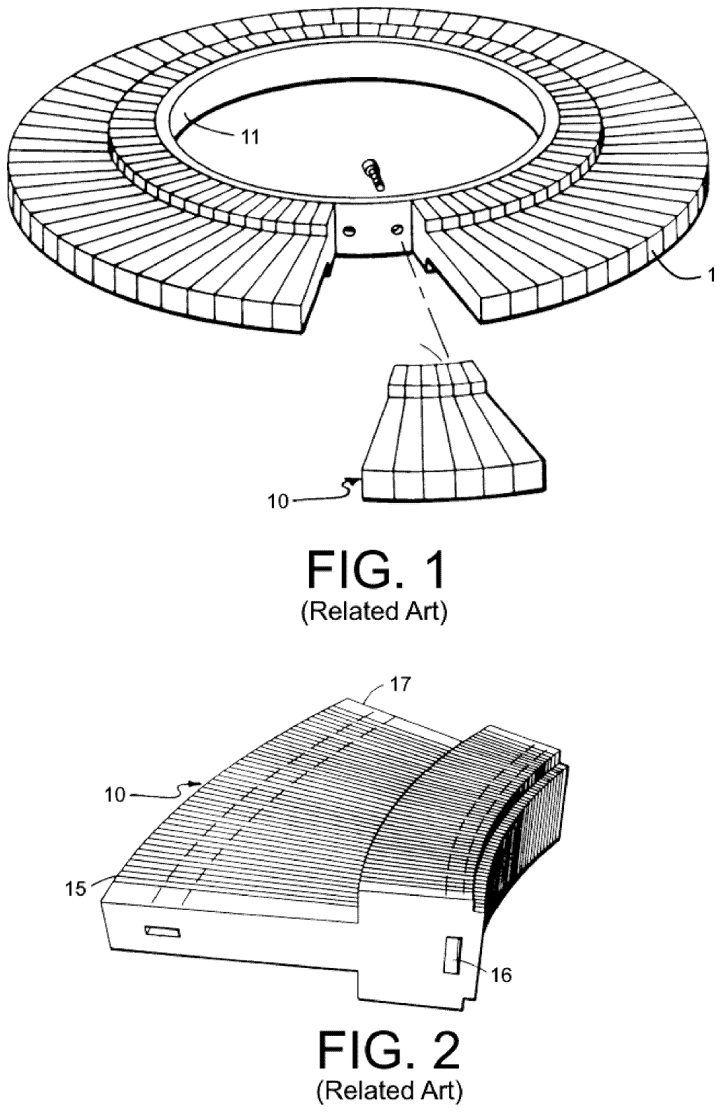

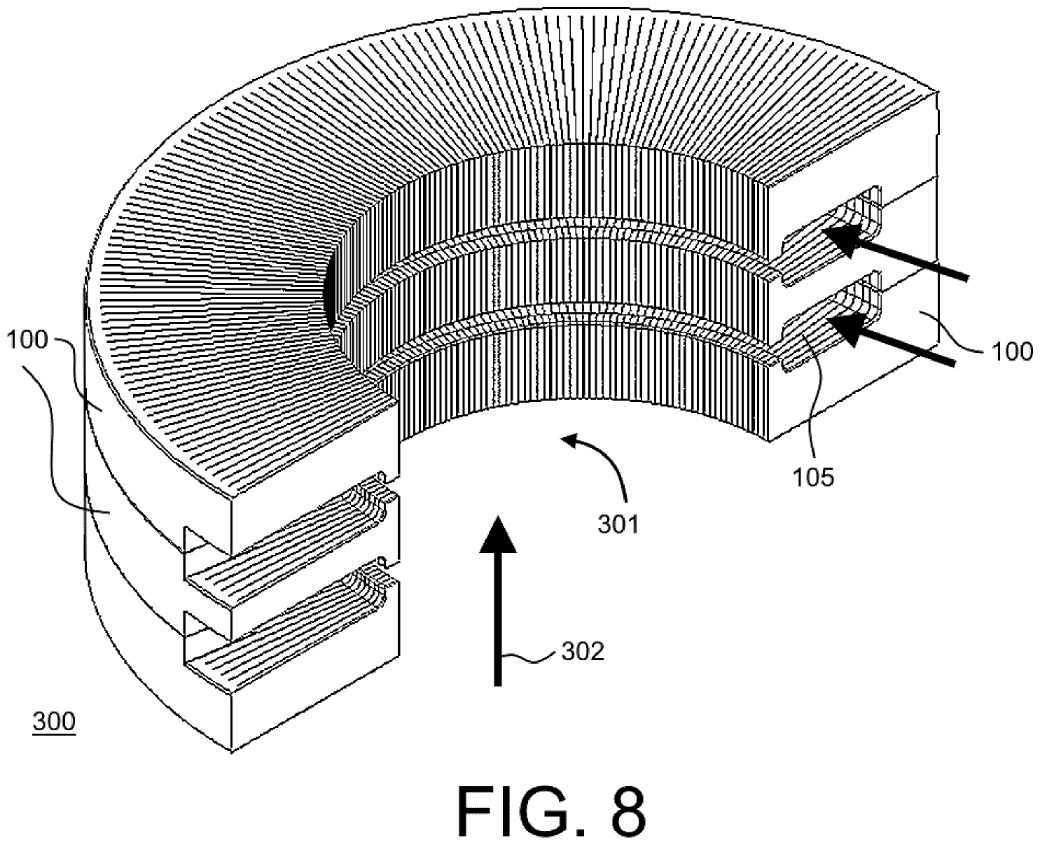

FIG. 8 is an illustration of an example embodiment electromagnetic pump 300 including a stack of example embodiment cores 100 as outer stators surrounding a flow channel 301. As seen in FIG. 8, multiple cores 100 may be aligned and stacked. In this example, cores 100 may be half-annular sections, although smaller sections and different shapes of cores 100 are useable, similar to lamination sections without gaps and interrupting end pieces. An example shape for core 100 in FIG. 8 creates space for other stator electronics. For example, recesses 105 may match between cores 100 stacked vertically as in FIG. 1, which may form complete angular or perimeter channels for coils, as well as a radial entry for such coils, to induce magnetic field and operate cores 100 as stators.

As seen in FIGS. 4-5, recesses 105 may be machined, laser cut, etched, etc. from core 100, before or after the formation of slots 101 and remainder of core 100 from a parent magnetic material. Recesses 105 may compliment each other across cores 100 when stacked or otherwise aligned, such as to form radial passages or openings to allow induction coils to pass into and out of stack of cores 100. For example, in FIG. 8, by running electrical current in a radial direction through passages formed by recesses 105, electromagnetic flow 302 may be induced in flow channel 301 using stacked cores 100 as an outer stator in an electromagnetic pump.

Example embodiment cores 100 and 200, including any reshaping or resizing thereof, are useable as stators or magnetic elements in a wide array of electromagnetic devices. For example, cores 100 and 200 could be used as outer and inner ferromagnetic stators, with appropriate coils running through them providing inductive current, in electromagnetic pumps. Cores 100 or 200 may be shaped, sized, and otherwise configured to accommodate any flow shape and case size, to replace known stators in existing electromagnetic pumps, and/or replace stators at the fabrication of any electromagnetic pump, including those found in US Pat Pub 2020/0403555 to Mills; US Pat Pub 2011/0280737 to Sarkinen et al.; CA Pat Pub 3187103 to Corbin; US Pat Pub 2003/0102352 to Aizawa et al.; and US Pat Pub 2022/0372973 to Dupeu et al., and U.S. patent application Ser. No. 18/428,629 filed Jan. 31, 2024 by Meek et al. for ELECTROMAGNETIC PUMPS AND METHODS OF OPERATING THE SAME WITH IMPROVED COOLING, all incorporated by reference herein in their entireties.

Example embodiments may allow increased usage of magnetic domains by avoiding gaps caused by fitting shapes and elements required by related art assembled lamination sections. Especially in pumps using larger cores where lamination sections lose coverage at outer radial positions, example embodiment cores may provide 15-40% increased magnetic field by having more densely-packed magnetic material. Example cores further reduce the need for assembly and combining parts, where they may be a single integral piece of rigid material. In this way, example cores can be formed into more complex and customized shapes without attendant increases in support and joining structures. Because example embodiments may be formed through relatively simple cutting only, fabrication costs of assembling individual teeth in lamination packs may be avoided. In these and other ways, example embodiment cores may lower fabrication costs while boosting performance of electromagnetic devices.

The inventors verified the performance of example embodiment cores 100 and 200 used as inner and outer electromagnetic pump stators. Parasitic and azimuthal currents in solid portions, such as solid sections 103 and 203, were analyzed in particular as related art lamination packs may generally avoid such connections where current may pass between joined pieces. When solid sections are kept small and/or at an edge that may experience less magnetic field or induced current, the unwanted currents developed in solid sections did not degrade performance, and the above driving efficiencies were still achieved.

Example embodiment cores may use any materials compatible with an operating nuclear reactor environment, including radiation-resilient materials that maintain their physical characteristics when exposed to high-temperature fluids, liquid metals, and radiation without substantially changing in physical properties, such as becoming substantially radioactive, melting, brittling, retaining/adsorbing radioactive particulates, etc. For example, magnetic materials, including iron and ferromagnetic alloys, as well as inert and high-temperature insulations including air gaps, are useable for cores and components interacting with the same at several hundred degrees Celsius. Conductive, high-temperature materials including insulated and plated copper and/or nickel are similarly useable for coil in example embodiment pumps using example cores as stators. Similarly, direct connections between distinct parts and all other direct contact points may be lubricated, insulated, and/or fabricated of alternating or otherwise compatible materials to prevent seizing, fouling, metal-on-metal reactions, conductive heat loss, etc.

Some example embodiments and methods thus being described, it will be appreciated by one skilled in the art that examples may be varied through routine experimentation and without further inventive activity. For example, although some annular shapes and sections of cores are the target of some example embodiments and methods, it is understood that any other shapes and sizes are useable with example embodiments and methods. Variations are not to be regarded as departure from the spirit and scope of the example embodiments, and all such modifications as would be obvious to one skilled in the art are intended to be included within the scope of the following claims.

1. A core useable in an electromagnetic device, the core comprising:
a plurality of teeth aligned with a magnetic field of the core, wherein each tooth is formed by two adjacent slots in the core; and
a solid section joining all the teeth, wherein the solid section and the teeth are materially continuous.

2. The core of claim 1, wherein the core forms a curved shape about its axis, wherein the slots extend in a radial direction into the curved shape, and wherein the solid section is beyond the slots in the radial direction.

3. The core of claim 2, wherein the curved shape is annular, and wherein the slots extend a complete axial height of the core and at least 80% of the core in the radial direction.

4. The core of claim 3, further comprising:
an axial recess extending entirely through the core in an angular direction with a radial passage through the solid section.

5. The core of claim 4, wherein the recess does not extend entirely through the core in the radial direction.

6. The core of claim 1, further comprising:
insulation fully filling all the slots between the teeth.

7. The core of claim 1, wherein the teeth and solid section are all completely a solid magnetic material.

8. The core of claim 7, wherein the entire core is a single piece of a ferromagnetic material.

9. The core of claim 1, wherein the slots are formed by machining, and wherein the slots are less than 0.01-inch thick and extend an entire axial height of the core.

10. An electromotive device comprising:
a plurality of the cores of claim 1 aligned to form a flow passage around the cores.

11. The device of claim 10, wherein the device is an electromagnetic pump.

12. The device of claim 10, wherein the plurality of cores are further aligned to align all teeth between the cores in at least one of an axial direction and a radial direction.

13. The device of claim 10, wherein the plurality of cores are aligned in a vertical stack, and where each core includes at least one recess in the axial direction, and wherein two of the recesses of directly adjacent cores align to form a coil passage through the vertical stack.

14. The device of claim 13, wherein the at least one recess further includes a passage through the solid section to form an external entry into the coil passage.

15. A method of manufacturing a core for an electromagnetic device, the method comprising:
cutting a plurality of slots into the core so as to form a plurality of teeth aligned with a magnetic field of the core, wherein each tooth is formed by two adjacent slots in the core, and wherein the cutting is to a partial width of the core so as to retain a solid section joining all the teeth of the core.

16. The method of claim 15, wherein the cutting is performed by at least one of electrical discharge machining, water jetting, and laser cutting.

17. The method of claim 16, wherein the cutting is performed to each of the slots is 0.01-inches or less in thickness and an entire axial height of the core.

18. The method of claim 15, wherein the cutting is performed on a core that is a single piece of continuous ferromagnetic material.

19. The method of claim 15, further comprising:
removing a recess in the core across a length and to a height of the core both perpendicular to the width, wherein the removing is performed before the cutting, and wherein the recess further extends in the length direction through the solid section and less than all of the solid section.

20. The method of claim 15, further comprising:
applying an insulator in the slots so as to form solid insulation between the teeth.
